(19) United States
(12) Patent Application Publication
(10) Pub. No.: US 2008/0201088 A1
(43) Pub. Date: Aug. 21, 2008

(54) SYSTEM AND METHOD FOR MONITORING A PROCESS

(75) Inventor: Gayle W. Miller, Colorado Springs, CO (US)

Correspondence Address: SCHWEGMAN, LUNDBERG & WOESSNER / ATMEL, P.O. BOX 2938, MINNEAPOLIS, MN, 55402, US

(73) Assignee: Atmel Corporation, San Jose, CA (US)

(21) Appl. No.: 11/677,020

(22) Filed: Feb. 20, 2007

(51) Int. Cl. G06F 19/00

(52) U.S. Cl. 702/56

(57) ABSTRACT

A system and method for monitoring a process. The system includes a processing chamber for receiving a workpiece, a processor coupled to the processing chamber, and at least one surface acoustic wave (SAW) device coupled to the workpiece, and wherein the processor utilizes the at least one SAW device to determine the conditions of the workpiece during processing. According to the method and system disclosed herein, the present invention provides inexpensive, accurate, and abundant information to control a process.

### FIELD OF THE INVENTION

The present invention relates to process monitors, and more particularly to a system and method for monitoring a process.

### BACKGROUND OF THE INVENTION

During the processing of a workpiece, such as a semiconductor wafer, in a processing chamber, it is important to maintain relatively precise control of the conditions, such as temperature, of the workpiece during the processing steps associated with the manufacture of the workpiece. For example, a number of the processing steps associated with wafer fabrication involve complex chemical reactions, which require the temperature of the wafer to be controlled within predetermined specifications.

Sensors such as temperature sensors are often utilized within a processing chamber to measure the temperature of the air or other gas within the chamber.

Another conventional solution is to secure thermocouples to a wafer-handling device in order to measure the temperature of the handling device. A problem with this conventional solution is that the temperature of the wafer is still estimated or otherwise derived from the temperature of the handling device. Also, securing the thermalcouples requires perfect thermal contact between thermocouple and the workpiece. Thermal contact between a thermocouple and a workpiece is difficult to control. The same factors that improve thermal contact (of the thermocouple) cause increased physical interaction that damages either the workpiece or the thermocouple. Furthermore, intimate contact between the thermocouple and the workpiece disturbs the alignment of the thermocouple with respect to the workpiece, as the workpieces must be moved during loading and unloading. Furthermore, reactive atmospheres or environments often permanently degrade or damage the thermocouple, because reactive atmospheres or environments cause contamination, including the byproducts of corrosion, on the surface of the thermocouple, which contamination degrades thermal contact with the workpiece. In general, it is difficult to keep the thermocouple surface adequately clean for good thermal contact.

Another conventional solution is to gauge the temperature of the workpiece from its emitted optical or black-body radiation. This method has disadvantages, also. The emissivity of workpieces is usually not consistent enough to provide accurate information. In some cases, a massive “liner” structure is added in the chamber, which structure is placed in intimate contact with the workpiece; and the radiation from the liner is used in place of the radiation from the wafer to gauge the temperature of the wafer. The added mass of the liner, and its less than perfect thermal conductivity, impact both the ease of thermal articulation of the workpiece and the assessment of its temperature. In many cases, this approach provides a significant limit to the performance of the system.

Accordingly, the feedback provided by the conventional solutions does not provide adequate and reliable information during the processing of a workpiece.

Accordingly, what is needed is an improved system and method for monitoring the processing conditions during the manufacturing process. The system and method should be simple, cost effective, and capable of being easily adapted to existing technology. The present invention addresses such a need.

### SUMMARY OF THE INVENTION

A system and method for monitoring a process is disclosed. The system includes a processing chamber for receiving a workpiece, a processor coupled to the processing chamber, and at least one surface acoustic wave (SAW) device coupled to the workpiece, and wherein the processor utilizes the at least one SAW device to determine the conditions of the workpiece during processing. According to the system and method disclosed herein, the present invention provides inexpensive, accurate, and abundant information to control a process.

### BRIEF DESCRIPTION OF THE DRAWINGS

FIG. 1 is a side-view diagram of a process monitor system in accordance with the present invention.

FIG. 2 is flow chart showing a method for monitoring the conditions of the workpiece of FIG. 1, in accordance with the present invention.

FIG. 3 is a top-view diagram of the chuck of FIG. 1, including the interrogating transducers, in accordance with the present invention.

FIG. 4 is a top-view diagram of the workpiece of FIG. 1, including the SAW devices, in accordance with the present invention.

FIG. 5 is a partial side-view diagram of the chuck and the workpiece of FIG. 1, in accordance with the present invention.

FIG. 6 is a top-view diagram of the SAW device of FIG. 4, in accordance with the present invention.

FIG. 7 is flow chart showing a method for monitoring the conditions of the workpiece of FIG. 1, in accordance with the present invention.

### DETAILED DESCRIPTION OF THE INVENTION

The present invention relates to process monitors, and more particularly to a system and method for monitoring a process. The following description is presented to enable one of ordinary skill in the art to make and use the invention, and is provided in the context of a patent application and its requirements. Various modifications to the preferred embodiment and the generic principles and features described herein will be readily apparent to those skilled in the art. Thus, the present invention is not intended to be limited to the embodiment shown, but is to be accorded the widest scope consistent with the principles and features described herein.

A system and method in accordance with the present invention for monitoring a process are disclosed. The system includes a processing chamber for receiving a workpiece, a processor coupled to the processing chamber, and surface acoustic wave (SAW) devices coupled to the workpiece. Interrogating transducers are used to excite the SAW devices, and to pass radio frequency (RF) signals from the SAW devices to the processor when the workpiece is subjected to a radiated field. The processor then determines the conditions of the workpiece during processing based on the RF signal. According to the method and system disclosed herein, the present invention provides inexpensive, accurate, and abundant information to control a process. To more particularly describe the features of the present invention, refer now to the following description in conjunction with the accompanying figures.

Although the present invention disclosed herein is described in the context of temperature, the present invention may apply to other environmental conditions, and still remain within the spirit and scope of the present invention.

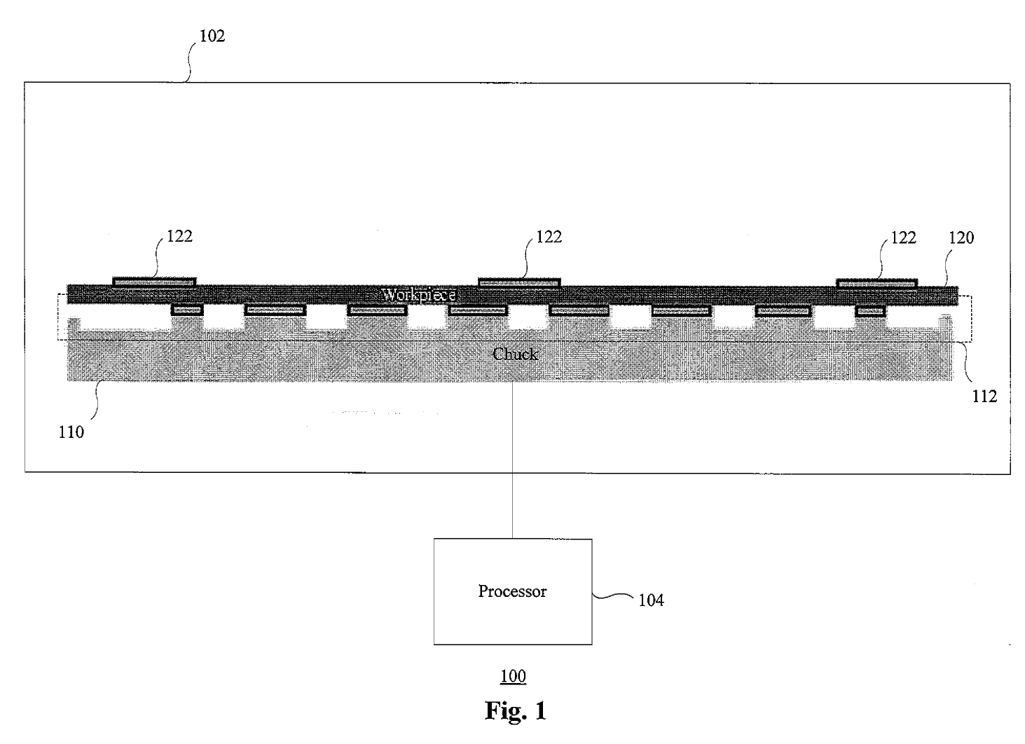

FIG. 1 is a side-view diagram of a process monitor system 100 in accordance with the present invention. The process monitor system 100 includes a processing chamber 102, a processor 104, a chuck 110, interrogating transducers 1 12, a workpiece 120, and SAW devices 122. The chuck 1 10 functions to hold the workpiece 120 in a fixed location during processing. The workpiece 120 is positioned on the surface of the chuck 110, immediately adjacent to and on top of the interrogating transducers 112, which are embedded in the top surface of the chuck 110. The SAW devices 122 are embedded in the top surface of the workpiece 120.

In an alternative embodiment, the interrogating transducers 112 can be positioned above the surface of the workpiece 120, either embedded in the inner surfaces of the processing chamber 102 or supported on gas distribution and/or heating elements also contained in the processing chamber 102.

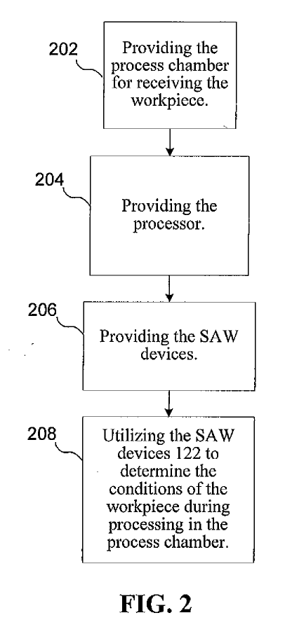

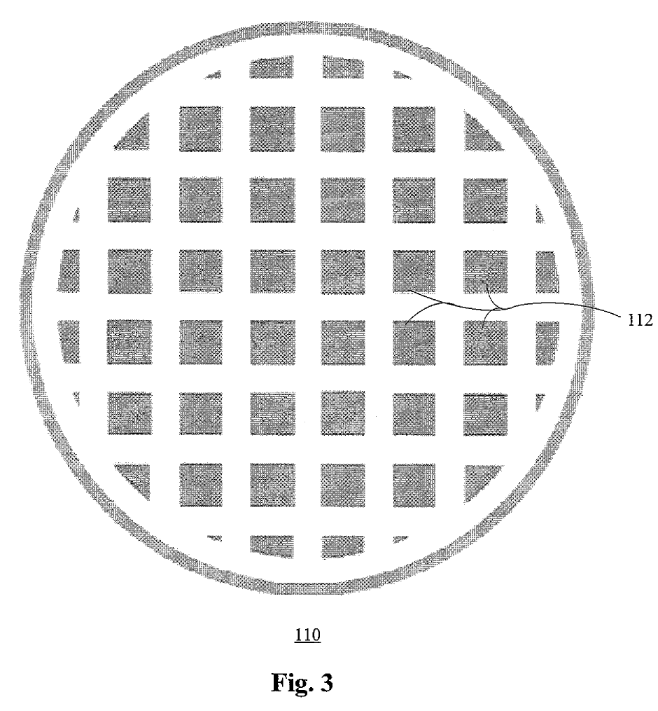

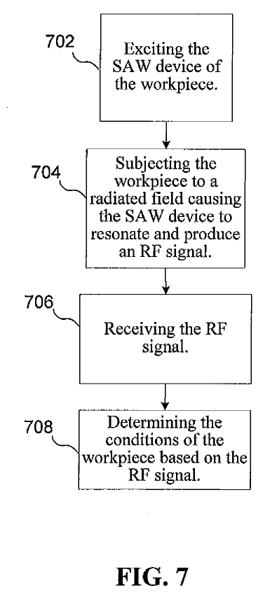

For ease of illustration, the operation of the process monitor system 100 is described at a high level in FIG. 2 below and described in more detail in FIG. 7 below, after the descriptions of FIGS. 3 to 6.

FIG. 2 is flow chart showing a method for monitoring the conditions of the workpiece 120 of FIG. 1, in accordance with the present invention. Referring to both FIGS. 1 and 2 together, the process begins in a step 202 where the processing chamber 102 for receiving the workpiece 120 is provided. Next, in a step 204, the processor 104 is provided. Next, in a step 206, the SAW devices 122 are provided. The interrogating transducers 112 are used to excite the SAW devices 122, and to pass RF signals from the SAW devices 122 to the processor 104 when the workpiece 120 is subjected to a radiated field. Next, in a step 208, the processor 104 utilizes the SAW devices 122 to determine the conditions of the workpiece 120 during processing in the processing chamber 102.

FIG. 3 is a top-view diagram of the chuck 110 of FIG. 1, including the interrogating transducers 112, in accordance with the present invention. The chuck 110 is preferably an electrostatic chuck but may also be other types of chucks (e.g. a vacuum chuck), which can hold on to the workpiece 120.

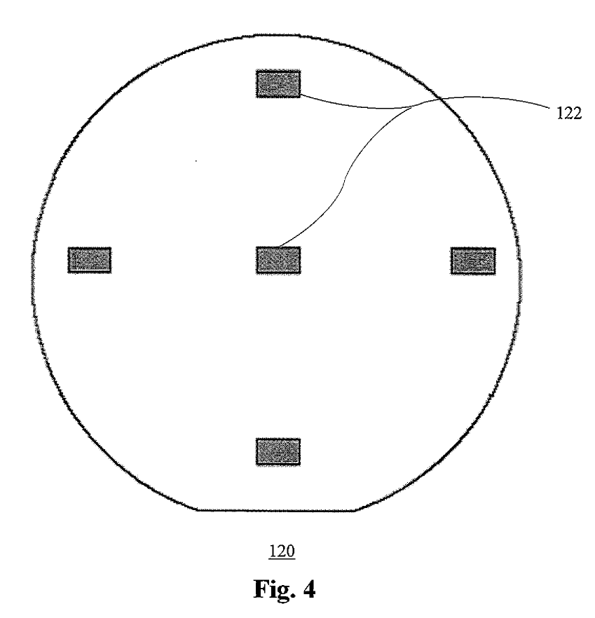

FIG. 4 is a top-view diagram of the workpiece 120 of FIG. 1, including the SAW devices 122, in accordance with the present invention. In this specific embodiment, the workpiece 120 is a silicon wafer. Alternatively, the workpiece 120 can be a liquid crystal or flat panel display, etc. As shown, the SAW devices 122 are positioned at various locations on the workpiece 120.

For ease of illustration, only five SAW devices 122 are shown. Although the present invention is described in the context of five SAW devices 122, one of ordinary skill in the art will readily recognize that there could be any number of SAW devices 122 and still be within the spirit and scope of the present invention. For example, there are preferably as many SAW devices 122 as there are interrogating transducers 112, with a one-to-one correspondence between the SAW devices 122 and the interrogating transducers 112. Implementing more SAW devices 122 provides more feedback as to the conditions (e.g. temperatures) at different locations on the workpiece 120.

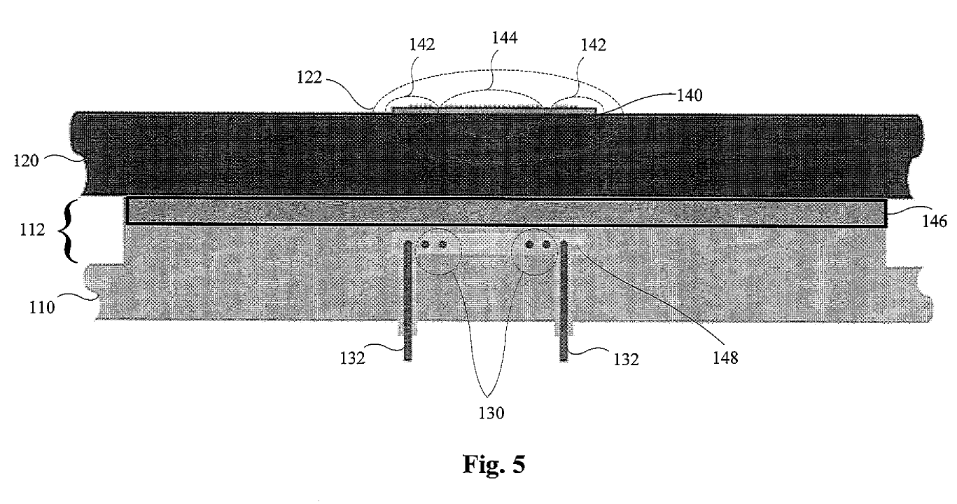

FIG. 5 is a partial side-view diagram of the chuck 110 and the workpiece 120 of FIG. 1, in accordance with the present invention. Also shown is an interrogating transducer 112 and a SAW device 122. In one embodiment, there may be one SAW device 122 present on the chuck 100. However, in other embodiments, there may be more than one SAW device 122 present on the chuck 100. In one embodiment, SAW devices of different characteristic frequencies may be provided on the same substrate. In one embodiment, the interrogating transducer 112 may operate at a wide range of frequencies. Also, there may be more than one interrogating transducer 112. In one embodiment, to access more than one interrogating transducers, frequency division multiple access (FDMA), time division multiple access (TDMA), code division multiple access (CDMA), space division multiple access (SDMA) or combinations of these may be used. The interrogating transducer 112 includes a folded RF or microwave transmitting and receiving antenna array 130 and electrical connectors 132 to the antenna array 130. The SAW device 122 includes a piezoelectric base 140, tuned reflector arrays 142, and a resonator array 144.

The chuck 110 is a machined plate. If the chuck 110 were an electrostatic chuck, the machined plate would be metal and would have a bias to attract the workpiece 120. Otherwise, the chuck 110 can be any material. The chuck 110 has a dialectric material 146 layered on its top surface. The antenna array 130 is passivated in another dialectric material 148, which is inert (e.g. air), and is connected to the electrical connectors 132, which feed outside the processing chamber 102 (FIG. 1) to the processor 104. If the chuck 110 is an electrostatic chuck, the dialectric material 148 would preferably make contact with the dialectric material 146.

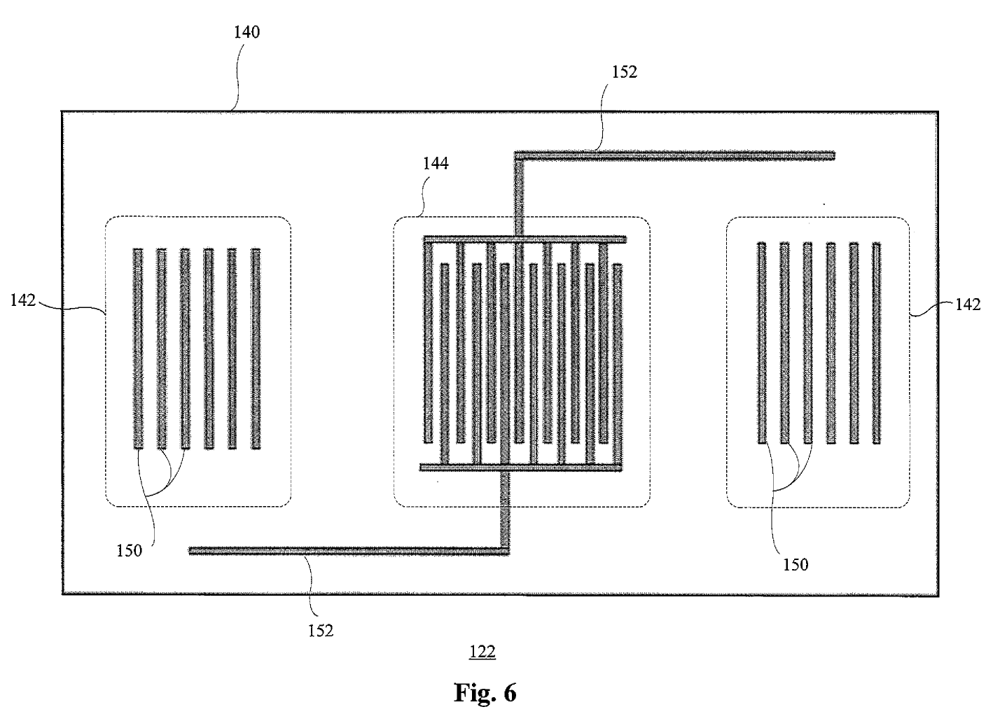

FIG. 6 is a top-view diagram of the SAW device 122 of FIG. 4, including the piezoelectric base 140, the tuned reflector arrays 142, which include conductive fingers 150, the resonator array 144, and tuned antennas 152, in accordance with the present invention. The piezoelectric base 140 is preferably quartz but may also be other types of materials, such as ZnO.

FIG. 7 is flow chart showing a method for monitoring the conditions of the workpiece 120 of FIG. 1, in accordance with the present invention. Referring to both FIGS. 5, 6, and 7 together, the process begins in a step 702 where the interrogating transducer 112 excites the SAW device 122 of the workpiece 120. Specifically, an RF or microwave signal is applied to the antenna array 130 via the electrical connectors 132. The antenna array 130 emits the RF signal, which excites the SAW device 122, which functions as a conductor to conduct the RF signal. This causes the resonator array 144 of the SAW device 122 to resonate.

Next, in a step 704, the workpiece 120 is subjected to a radiated field causing the SAW device 120 to resonate and produce an RF signal having a characteristic frequency. The radiated field may be generated by thermal or ion bombardment, physical deposition processing, or chemical processing at an elevated temperature. The radiated field causes a reaction in the materials on the workpiece 120. Specifically, the tuned antennas 152 (FIG. 6) receive the radiated field. This puts mechanical stress on the piezoelectric base 140 and causes mechanical changes to the dimensions of the piezoelectric base 140, which causes it to oscillate. The radiated field affects the amount of mechanical change to the mechanical dimensions and the oscillation of the piezoelectric base 140.

The resonator array 144 produces a resonant signal, which is reflected at the reflector arrays 142. In one embodiment, the interrogating transducer 112 may also produce the resonant signal. The frequency of the resonant signal is affected by the spacing of the conductive fingers 150, which also change and oscillate, reflecting the oscillations of the SAW device 120. Accordingly, the mechanical properties of the piezoelectric base 140 affect the resonant signal.

When the excitation induced by the interrogating transducer 112 is turned off, the SAW device 120 continues to resonate and produces an RF signal having a characteristic frequency.

Next, in a step 706, the RF signal is received by the interrogating transducer 112. Specifically, the antenna array 130 receives the RF signal from the SAW device 120. The transmitting frequency originally sent from the interrogating transducer 112 to the SAW device 120 is not critical and is within a certain frequency range. The resonant frequency of the signal from the SAW device 120 to the interrogating transducer 112 reflects the conditions (e.g. the temperature) of the SAW device 120 and the workpiece 120 since the two are integrated. The interrogating transducer 112 then sends the RF signal to the processor 102.

Next, in a step 708, the processor 104 then determines the conditions of the workpiece 120 based on the characteristic frequency of the RF signal.

Although the present invention disclosed herein is described in the context of temperature, the present invention may apply to other environmental conditions, and still remain within the spirit and scope of the present invention. For example, in an alternative embodiment, a thin film layer can be deposited on the top surface of the workpiece 120 to enable the SAW devices 122 to respond to particular radiated fields depending on the type of thin film layer used. Furthermore, the SAW devices 122 may respond to “smell” (trace chemical absorption or even adsorption), pressure, and acceleration. Electric fields and even magnetic fields may also be detected, depending on the materials selected or even using the basic construction discussed above. Chemical absorption or surface adsorption in the piezoelectric material, or in any passivating or superimposed material added by design, can change the characteristic frequency response of the transducer. Depending on the orientation of the SAW device in the workpiece, or by using multiple orientations, or by design of the system configuration, pressure and acceleration may be gauged even independently.

According to the system and method disclosed herein, the present invention provides numerous benefits. For example, it provides inexpensive, accurate, and abundant information to control a process.

A system and method in accordance with the present invention for monitoring a process has been disclosed. The system includes a processing chamber for receiving a workpiece, a processor coupled to the processing chamber, and SAW devices coupled to the workpiece. Interrogating transducers are used to excite the SAW devices, and to pass RF signals from the SAW devices to the processor when the workpiece is subjected to a radiated field. The processor then determines the conditions of the workpiece during processing based on the RF signal. According to the method and system disclosed herein, the present invention provides inexpensive, accurate, and abundant information to control a process.

The present invention has been described in accordance with the embodiments shown. One of ordinary skill in the art will readily recognize that there could be variations to the embodiments, and that any variations would be within the spirit and scope of the present invention. For example, the present invention can be implemented using hardware, software, a computer readable medium containing program instructions, or a combination thereof. Software written according to the present invention is to be either stored in some form of computer-readable medium such as memory or CD-ROM, or is to be transmitted over a network, and is to be executed by a processor. Consequently, a computer-readable medium is intended to include a computer readable signal, which may be, for example, transmitted over a network. Accordingly, many modifications may be made by one of ordinary skill in the art without departing from the spirit and scope of the appended claims.

1. A system for monitoring a process, the system comprising:
a processing chamber for receiving a workpiece;
a processor coupled to the processing chamber; and
at least one surface acoustic wave (SAW) device coupled to the workpiece, and wherein the processor utilizes the at least one SAW device to determine the conditions of the workpiece during processing.

2. The system of claim 1 further comprising a chuck coupled to the processor, wherein the chuck comprises at least one transducer for exciting the at least one SAW device.

3. The system of claim 2 wherein the at least one transducer comprises:
an antenna array; and
at least one electrical connector coupled to the antenna array.

4. The system of claim 3 wherein the antenna array sends a first signal to the at least one SAW device to excite the at least one SAW device and receives a second signal from the at least one SAW device when the SAW device is subjected to a radiated field.

5. The system of claim 3 wherein the chuck comprises:
a first dielectric material coupled to a top surface of the chuck; and
a second dielectric material to house the antenna array and the at least one electrical connector.

6. The system of claim 5 wherein the first and dielectric materials make direct contact with each other.

7. The system of claim 1 wherein the at least one SAW device comprises:
a piezoelectric base;
a resonator array coupled to the piezoelectric base; and
at least one tuned reflector array coupled to the piezoelectric base.

8. The system of claim 1 wherein the conditions comprise temperature.

9. A system for monitoring a process, the system comprising:
a processing chamber for receiving a workpiece;
a processor coupled to the processing chamber;
at least one surface acoustic wave (SAW) device coupled to the workpiece,
wherein the at least one SAW device comprises:
a piezoelectric base;
a resonator array coupled to the piezoelectric base; and
at least one tuned reflector array coupled to the piezoelectric base;
a chuck coupled to the processor, wherein the chuck comprises at least one transducer for exciting the at least one SAW device, wherein the at least one transducer comprises:
an antenna array; and
at least one electrical connector coupled to the antenna array, wherein the processor utilizes the at least one SAW device to determine the conditions of the workpiece during processing.

10. The system of claim 9 wherein the antenna array sends a first signal to the at least one SAW device to excite the at least one SAW device and receives a second signal from the at least one SAW device when the SAW device is subjected to a radiated field.

11. The system of claim 9 wherein the chuck comprises:
a first dielectric material coupled to a top surface of the chuck; and
a second dielectric material to house the antenna array and the at least one electrical connector.

12. The system of claim 11 wherein the first and dielectric materials make direct contact with each other.

13. The system of claim 9 wherein the conditions comprise temperature.

14. A method for monitoring a process, the method comprising:
providing a processing chamber for receiving a workpiece;
providing at least one SAW device; and
utilizing the at least one SAW device to determine the conditions of the workpiece during processing in the processing chamber.

15. The method of claim 14 further comprising:
exciting the at least one SAW device;
subjecting the workpiece to a radiated field causing the at least one SAW device to resonate and produce a signal;
receiving the signal at a transducer; and
determining the conditions of the workpiece based on the signal.

16. The method of claim 15 wherein the signal comprises a resonant frequency that reflects the conditions of the at least one SAW device and the workpiece.

17. The system of claim 14 wherein the conditions comprise temperature.

18. A computer readable medium containing program instructions for monitoring a process, the program instructions which when executed by a computer system cause the computer system to execute a method comprising:
providing a processing chamber for receiving a workpiece;
providing at least one SAW device; and
utilizing the at least one SAW device to determine the conditions of the workpiece during processing in the processing chamber.

19. The computer readable medium of claim 18 further comprising program instructions for:
exciting the at least one SAW device;
subjecting the workpiece to a radiated field causing the at least one SAW device to resonate and produce a signal;
receiving the signal at a transducer; and
determining the conditions of the workpiece based on the signal.

20. The computer readable medium of claim 18 wherein the signal comprises a resonant frequency that reflects the conditions of the at least one SAW device and the workpiece.

21. The system of claim 18 wherein the conditions comprise temperature.
